(19) United States
(12) Patent Application Publication
(10) Pub. No.: US 2024/0332637 A1
(43) Pub. Date: Oct. 3, 2024

(54) BATTERY MODULE CUT-OUT WIRE SYSTEM

(71) Applicant: GM GLOBAL TECHNOLOGY OPERATIONS LLC, Detroit, MI (US)

(72) Inventor: Andrew P. Oury, Troy, MI (US)

(73) Assignee: GM GLOBAL TECHNOLOGY OPERATIONS LLC, Detroit, MI (US)

(21) Appl. No.: 18/194,747

(22) Filed: Apr. 3, 2023

(51) Int. Cl. H01M 10/42; H01M 10/6554; H01M 50/204

(52) U.S. Cl. CPC H01M 10/4207; H01M 10/6554; H01M 50/204

(57) ABSTRACT

A separator mechanism for battery modules and methods of removing battery modules. The mechanism includes a battery pack having a first battery module and an adhesive configured to bond the first battery module to at least one other structure. A cut-out wire is configured to separate the adhesive between the first battery module and the other structure. The other structure may be a second battery module of the battery pack or a cold plate, such that the adhesive bonds the first battery module to second battery module or cold plate. The mechanism may include an attachment mechanism for attaching the cut-out wire to an automatic pulling system. The cut-out wire may be installed concurrently with the first battery module or after the first battery module is installed. One or more handles may be attached to one or more ends of the cut-out wire.

### INTRODUCTION

The present disclosure relates to methods or structures for removing battery modules from battery packs or pack assemblies.

### SUMMARY

A separator mechanism for battery modules and a method of removing a battery module are provided. The mechanism includes a battery pack having a first battery module and an adhesive configured to bond the first battery module to at least one other structure. A cut-out wire is configured to separate the adhesive between the first battery module and the other structure.

In some configurations the other structure is a second battery module of the battery pack, such that the adhesive is configured to bond the first battery module to the second battery module. In other configurations the other structure is a cold plate, such that the adhesive bonds the first battery module to the cold plate.

The separator mechanism may include an attachment mechanism for attaching the cut-out wire to an automatic pulling system. In some configurations the cut-out wire is installed concurrently with the first battery module, but, in others, the cut-out wire is installed after the first battery module is installed. One or more handles may be attached to one or more ends of the cut-out wire.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic isometric view of a separator mechanism having a battery pack with one battery module attached to an adhesive and a cut-out wire.

FIG. 2 is a schematic side view of a cut-out wire with handles.

FIG. 3 is a schematic side view of two battery modules attached to a cold plate via adhesive and a cut-out wire with handles.

FIG. 4 is a schematic flow chart diagram of a method for removing one or more battery modules.

### DETAILED DESCRIPTION

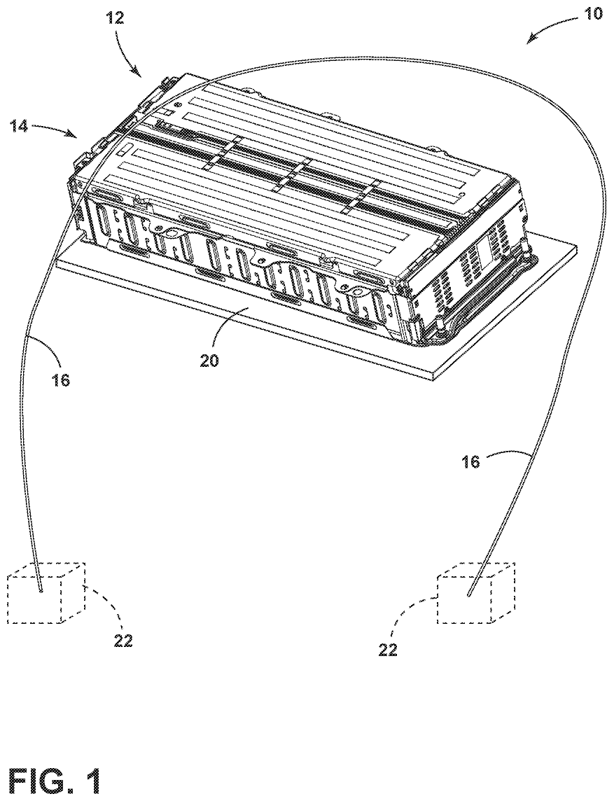

Referring to the drawings, like reference numbers refer to similar components, wherever possible. FIG. 1 schematically illustrates a separator mechanism 10, which may be used to separate portions of a battery pack 12, including one or more battery modules 14, via one or more cut-out wires 16.

An adhesive 20 bonds a first battery module 14 to at least one other structure or adjacent structure. The cut-out wire 16 is configured to separate the adhesive 20 between the first battery module 14 and the other structure, which, in this case, is a second battery module 14. In general, battery modules 14 consist of multiple battery cells connected in series and/or parallel, encased in some type of mechanical structure. As used herein, bonding may refer to holding fast or sticking, as if by gluing, suction, grasping, or fusing, or the attaching of a material to one or more other materials. The cut-out wire 16 includes at least one attachment mechanism 22.

The drawings and figures presented herein are diagrams, are not to scale, and are provided purely for descriptive purposes. Thus, any specific or relative dimensions or alignments shown in the drawings are not to be construed as limiting. While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

The term vehicle is broadly applied to any moving or rolling platform. Vehicles into which the disclosure may be incorporated include, for example and without limitation: passenger or freight vehicles; autonomous driving vehicles; industrial, construction, and mining equipment; and various types of aircraft. Additionally, the term vehicle may apply to conventional, electric, or hybrid vehicles.

All numerical values of parameters (e.g., of quantities or conditions) in this specification, including the appended claims, are to be understood as being modified in all instances by the term “about,” whether or not the term actually appears before the numerical value. About indicates that the stated numerical value allows some slight imprecision (with some approach to exactness in the value; about or reasonably close to the value; nearly). If the imprecision provided by about is not otherwise understood in the art with this ordinary meaning, then about as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

When used herein, the term “substantially” often refers to relationships that are ideally perfect, but where manufacturing realities prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be considered to be within 5%.

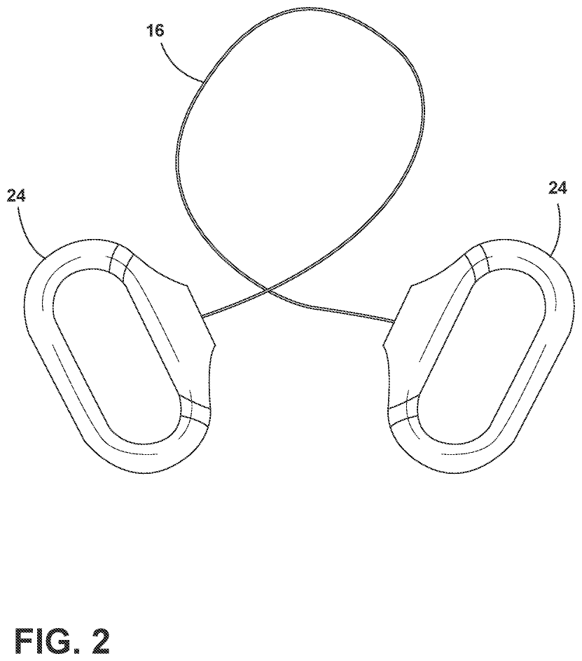

FIG. 2 shows a side view of the cut-out wire 16. As shown in FIG. 2, the attachment mechanisms 22 of the separator mechanism 10 are handles 24 attached to one or more ends of the cut-out wire 16. As shown in the figures, there may generally be two handles 24, one attached to each end of the cut-out wire 16.

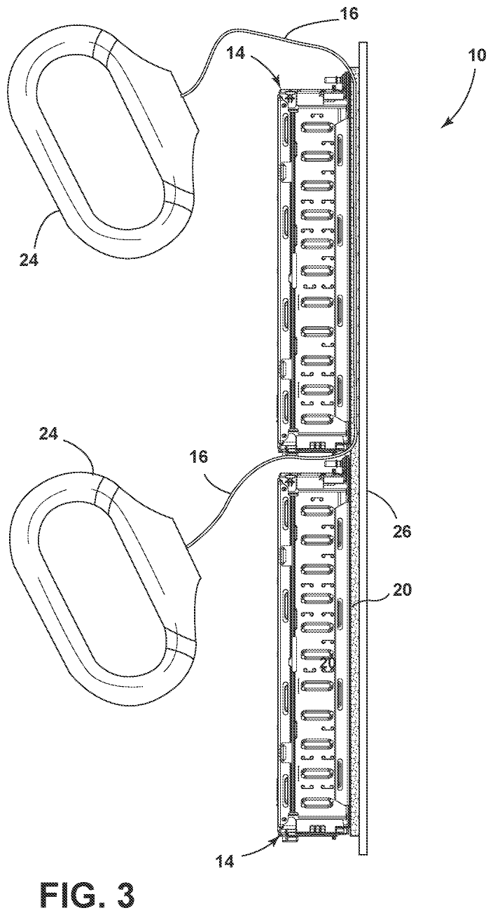

FIG. 3 shows a side view of a battery module 14 and a cold plate 26, such that the adhesive 20 bonds the first battery module 14 to the cold plate 26. In general, cold plates 26 generally provide localized cooling by transferring heat from a device, as will be recognized by skilled artisans. In some configurations, the cold plate 26 may transfer heat to a liquid that flows to a generally remote heat exchanger to dissipate that heat. When configured with heating elements within related systems, the cold plate 26 may also be used to provide heating, when/where wanted.

An automatic pulling system, or automatic winding system, could be, without limitation, a drilling or winding system that reals or pulls the cut-out wire 16 through the adhesive 20, as will be recognized by those having ordinary skill in the art. The attachment mechanisms 22 would vary, based on the type of automatic pulling system, as will be recognized by those having ordinary skill in the art. The automatic pulling system may be beneficial for the pulling through the adhesive 20, as opposed to utilizing hand strength of humans.

Note that the handles 24 may be part of, or form, the attachment mechanism 22 for the automatic pulling system, as would be recognized by those having ordinary skill in the art. The handles 24 may be configured for use either by a human or by the automatic pulling system. Additionally, the automatic pulling system may operate substantially without human inference-particularly after the attachment mechanisms 22 are connected to the automatic pulling system—as will be recognized by those having ordinary skill in the art.

There are several possible configurations for installing separator mechanisms 10. The examples listed herein are not limiting.

For example, the cut-out wire 16 may be installed, concurrently, with the battery pack 12 or one or more battery modules 14, substantially at the time of original installation. Contrarily, the cut-out wire 16 may be installed after the battery pack 12 or the battery module 14 is installed, such that it is a later addition, including when the battery module 14 or other portions of the battery pack 12, including the cold plate 26, needs some sort of service.

The cut-out wire 16 may be formed from, without limitation: steel or steel alloys, aluminum or aluminum, or synthetic fibers. The cut-out wire 16 may have, without limitation, a diameter of approximately, 0.9 mm to 1.5 mm and a tensile strength of 400-800 pounds. Furthermore, the cut-out wire 16 may include anti-abrasion coatings to prevent damage to sensitive battery components, including, without limitation, the cells or components connecting the cells. Additionally, the cut-out wire 16 may to be flexible so it can be tightly wound in the automatic pulling system that pulls the cut-out wire 16.

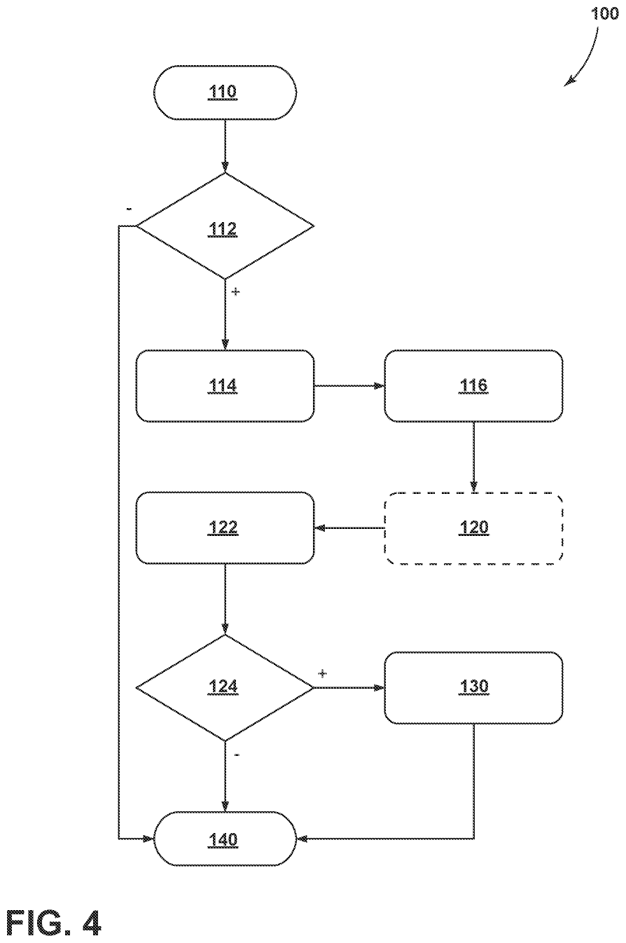

FIG. 4 is a schematic flow chart diagram of a method 100 for removing one or more battery modules 14. A generalized control system, computing system, or controller may be operatively in communication with relevant components of, at least, the battery pack 12 and the separator mechanism 10. The controller includes, for example and without limitation, a non-generalized, electronic control device having a preprogrammed digital computer or processor, a memory, storage, or non-transitory computer-readable storage medium used to store data such as control logic, instructions, lookup tables, etc., and a plurality of input/output peripherals, ports, or communication protocols.

One or more of the methods described herein may be executed by the controller, including the non-transitory computer-readable storage medium, or other structures or equipment recognizable to skilled artisans. All of the steps described herein may be optional, in addition to those explicitly stated as such, and all of the steps described may be reordered or removed.

### Step 110: Start.

The method 100 starts at step 110, which may be in response to a trigger or to the app turning on. Note that the methods described herein may be looping iteratively and/or constantly looking for trigger events to begin any of the processes described herein.

### Step 112: Pack Maintenance or Service Needed?

At step 112, the method 100 determines whether the battery pack 12 or the battery module 14 needs service. This may include numerous reasons for the maintenance, as will be recognized by those having ordinary skill in the art. If the method 100 determines that no maintenance or service is needed, the method 100 ends or loops.

### Step 114: Placing Cut-Out Wire.

The method 100 may then place the cut-out wire 16. Note that the cut-out wire 16 may have already been placed, if done during the original installation, or may be placed when needed for service. The cut-out wire 16 is placed in an area where it can separate the battery module 14 from either, or both, another battery module 14 or the cold plate 26.

However, note that the other battery module 14 and the cold plate 26 are only examples. The battery module 14 may be attached to numerous structures, and the method 100 may be used to separate from any structure recognizable by those having ordinary skill in the art.

### Step 116: Pulling Cut-Out Wire.

At step 116, the method 100 pulls the cut-out wire 16 through the adhesive 20 to separate the battery module 14 from whatever structure, or structures, to which it was attached.

### Step 120: Automated Pulling (Optional).

As discussed relative to FIG. 3, attachment mechanisms 22 for mechanically pulling the cut-out wire 16 may be utilized. Therefore, automatic, or automated, pulling systems may also be used to pull the cut-out wire 16 by the method 100.

Step 122: Separate Module from Other Structure.

Following pulling or automated pulling, the battery module 14 is separated from the other, substantially adjacent, structure or structures. Then, the battery module 14 may be removed for service and/or replacement following the service. Alternatively, the removed battery module 14 may be replaced with a new battery module 14, including, without limitation, where the removed battery module 14 was not able to be repaired or serviced. Note that, even when replaced, the removed battery module 14 may be subject to further service such that it can be used as a subsequent replacement.

### Step 124: Additional Separation?

At step 124, the method 100 determines whether additional separations of additional battery modules 14 are needed. If the method 100 determines that no additional separations are needed, the method 100 ends or loops.

### Step 130: Repeat Placing/Pulling.

If the method 100 determines that additional separations are needed, the method 100 may repeat the placing, including if the cut-out wire 16 is already placed, and, also, repeats the pulling steps.

### Step 140: END/LOOP. At Step 140, the Method 100 Ends or Loops.

The detailed description and the drawings or figures are supportive and descriptive of the subject matter herein. While some of the best modes and other embodiments have been described in detail, various alternative designs, embodiments, and configurations exist.

Furthermore, any examples shown in the drawings, or the characteristics of various examples mentioned in the present description, are not necessarily to be understood as examples independent of each other. Rather, it is possible that each of the characteristics described in one of the examples of an embodiment can be combined with one or a plurality of other desired characteristics from other examples, resulting in other examples not described in words or by reference to the drawings. Accordingly, such other examples fall within the framework of the scope of the appended claims.

1. A separator mechanism for battery modules, comprising:
a battery pack having a first battery module;
an adhesive configured to bond the first battery module to at least one other structure;
a cut-out wire; and
wherein the cut-out wire is configured to separate the adhesive between the first battery module and the other structure.

2. The separator mechanism of claim 1,
wherein the other structure includes a second battery module of the battery pack, and
wherein the adhesive is configured to bond the first battery module to the second battery module.

3. The separator mechanism of claim 1,
wherein the other structure includes a cold plate, and
wherein the adhesive bonds the first battery module to the cold plate.

4. The separator mechanism of claim 1, further comprising:
an attachment mechanism for attaching the cut-out wire to an automatic pulling system.

5. The separator mechanism of claim 1, wherein the cut-out wire is installed concurrently with the first battery module.

6. The separator mechanism of claim 1, wherein the cut-out wire is installed after the first battery module is installed.

7. The separator mechanism of claim 1, further comprising:
at least one handle attached to one or more ends of the cut-out wire.

8. The separator mechanism of claim 7, further comprising:
an automatic pulling system, where the at least one handle is configured to attach the cut-out wire to the automatic pulling system.

9. The separator mechanism of claim 8,
wherein the other structure is one of a second battery module or a cold plate, and
wherein the adhesive is configured to bond the first battery module to the second battery module or to the cold plate.

10. The separator mechanism of claim 1, further comprising:
an automatic pulling system;
an attachment mechanism for attaching the cut-out wire to the automatic pulling system, the attachment mechanism including two handles, one attached to each end of the cut-out wire.

11. The separator mechanism of claim 10, wherein the cut-out wire is installed substantially at installation of the first battery module.

12. A battery pack having a separator mechanism, comprising:
at least one battery module;
an adhesive bonding the at least one battery module to at least one other structure;
a cut-out wire, wherein the cut-out wire is configured to separate the adhesive between the at least one battery module and the at least one other structure; and
at least one handle attached to one or more ends of the cut-out wire.

13. The battery pack having the separator mechanism of claim 12,
wherein the other structure is an other battery module or a cold plate, and
wherein the adhesive bonds the at least one battery module to either the other battery module or the cold plate.

14. The battery pack having the separator mechanism of claim 13, further comprising:
a handle on each end of the cut-out wire;
wherein the separator mechanism further includes an automatic pulling system; and
wherein the handles attach to the automatic pulling system, such that the automatic pulling system pulls the cut-out wire.

15. A method of removing a battery module, comprising:
placing a wire between the battery module and an adjacent structure;
pulling the wire through an adhesive connecting the battery module to the adjacent structure; and
separating the battery module from the adjacent structure.

16. The method of claim 15,
wherein the adjacent structure from which the battery module is separated is one of another battery module or a cold plate.

17. The method of claim 16, wherein pulling the wire through the adhesive occurs via an automatic pulling system.
